(19) United States
(12) Patent Application Publication
(10) Pub. No.: US 2009/0254924 A1
(43) Pub. Date: Oct. 8, 2009

(54) OPERATING SYSTEM INTERFACES FOR VIRTUAL WIFI AND SOFTAP CAPABLE DRIVERS

(75) Inventors: Ani Anirudh, Redmond, WA (US); Anirban Banerjee, Issaquah, WA (US); Christopher D. Gual, Seattle, WA (US); Deyun Wu, Issaquah, WA (US); Hui Shen, Sammamish, WA (US); John W. Archer, Marysville, WA (US); Michael Bell, Auburn, WA (US); Mitesh K. Desai, Redmond, WA (US); Saurabh Mahajan, Redmond, WA (US); Senthilkumar Veluswami, Bellevue, WA (US); Xiong Jiang, Lynnwood, WA (US); Sundar P. Subramani, Bellevue, WA (US); Taroon Mandhana, Redmond, WA (US); Thomas W. Kuehnel, Seattle, WA (US); Yan Wu, Redmond, WA (US); Yi Lu, Sammamish, WA (US); David A. Roberts, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/098,161

(22) Filed: Apr. 4, 2008

(51) Int. Cl. G06F 3/00

(52) U.S. Cl. 719/321

(57) ABSTRACT

Some embodiments of the invention provide an interface between programmed instructions (e.g., an operating system) and a miniport driver configured to communicate with radio hardware on a computer. The interface may include components operable to invoke various wireless connectivity-related functionality implemented by the radio hardware and/or miniport driver. The functionality may, for example, include a capability whereby the computer may maintain simultaneous connections on a plurality of wireless networks using a single radio, and/or a capability whereby the computer may function as an access point for a wireless network.

### FIELD OF THE INVENTION

This invention relates to interfaces between an operating system and/or other programmed instructions executing on a computer and one or more drivers employed to access peripheral devices, such as a radio used for wireless network connectivity.

### BACKGROUND OF INVENTION

Co-pending U.S. patent application Ser. No. 11/874,962 discloses techniques whereby a computer may maintain simultaneous connections with a plurality of wireless networks using a single radio. In accordance with these techniques, a computer may establish a connection with a first wireless network, such as an 802.11 network through which the computer may connect with the Internet, at the same time that the computer maintains a connection with a second wireless network, such as an 802.11 mesh or other 802.11 ad hoc network or one or more other devices, using a single radio. As a result, the computer may support functions possible only with simultaneous connections to two or more wireless networks via a single radio. For example, a computer may establish simultaneous connections with two or more wireless networks while the computer is moving (e.g., while traveling in a vehicle) and switch seamlessly between the networks if a connection with one of the networks degrades, may simultaneously participate in two wireless or other ad hoc networks and serve as an interconnection between the networks, or may operate as an access point for a first wireless network while simultaneously maintaining a client connection to a second wireless network.

A computer equipped with this capability typically includes a set of programmed instructions that, when executed by the computer, provides an operating system for the computer. Radio hardware (e.g., a wireless network interface card, or NIC) employed by the computer may be constructed and arranged to send and receive wireless signals for communication with at least one device in a wireless network. The computer may include a driver and/or other programmed instructions through which it communicates with the radio hardware. For example, radio hardware may be made available by an independent vendor who also provides the driver and/or other programmed instructions through which the computer (e.g., the operating system and/or other programmed procedures) may communicate with, and invoke various functionality provided by, the radio. These programmed instructions are referred to herein for convenience as a “miniport driver,” although they need not be provided entirely in the form of a driver and may include any component(s) comprising a hardware interface adapted to communicate with radio hardware, provide control signals to radio hardware, and/or receive information regarding wireless signals received by radio hardware from one or more wireless networks.

In accordance with the techniques described in the above-referenced co-pending application, a miniport driver may be capable of presenting a plurality of virtual “ports” to the operating system on a computer, with each port being a virtual representation of a corresponding wireless network. As such, the operating system may initiate connections with, and receive signals from, a different wireless network on each port.

### SUMMARY OF INVENTION

Some embodiments of the invention provide an interface between an operating system and/or other programmed instructions executing on a computer and a miniport driver configured to communicate with radio hardware, to implement various wireless connectivity-related functionality. Such functionality may be implemented or provided by, for example, the radio hardware and/or miniport driver, and the interface may enable the operating system and/or other programmed instructions to invoke the functionality so that the computer may employ it (e.g., on a user's behalf). For example, in some embodiments, the functionality includes a capability whereby a computer may maintain simultaneous connections on a plurality of wireless networks using a single radio. In some embodiments, the functionality includes a capability whereby a computer may function not only as a station on a wireless network (e.g., as a wireless client which gains access to a network, such as the Internet, through an access point), but also as an access point, so that one or more other devices capable of wireless connectivity may gain access to a network (e.g., the Internet) via the computer.

An interface implemented in accordance with aspects of the current invention may take any of numerous forms. For example, in some embodiments, an interface may be implemented via programmed instructions, such as via one or more drivers that pass information and/or instructions between the operating system and the miniport driver. It should be appreciated, however, that the invention is not limited to such an implementation, as an interface may be implemented using hardware, software or any suitable combination thereof. When implemented as one or more drivers, each driver may be separate from, integrated with, or form a part of the operating system and/or miniport driver. For example, one or more of the drivers may form part of the operating system. The invention is not limited to any particular implementation.

In accordance with some embodiments of the invention, the interface includes one or more components that provide the capability to invoke functions or features implemented or provided by a miniport driver and/or radio hardware. For example, in some embodiments, one or more interface components may be capable of issuing calls to functions implemented by a miniport driver. A call may, for example, be accomplished using one or more objects or data constructs referred to herein for convenience as object identifiers, or OIDs. An OID is a conventional vehicle which may be employed to make a function call to one or more components that implement the Network Driver Interface Specification (NDIS). In general, NDIS provides a library of functions which are conventionally employed by miniport drivers as well as higher-lever protocol drivers. An OID may, for example, be used to transfer information between components that implement the NDIS specification. For example, an OID may be used to query information accessible to a miniport driver (e.g., information about the driver's or underlying radio hardware's overall capabilities or current status) and/or set certain variables employed by a miniport driver or underlying radio hardware (e.g., optional features the miniport driver should enable on the radio hardware and/or settings for a particular transmission). Of course, the invention is not limited to employing one or more OIDs (or any other form of object or data construct) to invoke functionality and transfer information between components, as any suitable vehicle(s) and/or technique(s) may be employed.

Some embodiments of the invention provide a computer comprising a processor for executing instructions; a set of computer executable instructions that, when executed by the processor, form an operating system for the computer, the operating system controlling one or more operations of the computer; a radio constructed and arranged to send and receive wireless signals for communication with at least one device in a wireless network; a miniport driver comprising a hardware interface adapted to communicate with the radio, provide control signals to the radio, and receive information regarding wireless signals received by the radio from at least one device via a wireless network; and an interface operable to invoke functionality implemented by the miniport driver, in response to a request issued by the operating system, the functionality relating to enabling the computer to maintain simultaneous connections with at least two wireless networks using the radio and/or to enabling the computer to operate as an access point for a wireless network; wherein the interface invokes the functionality by making a call to the miniport driver using at least one OID.

Other embodiments of the invention provide a method for use in a computer comprising an operating system, a radio operable to send and receive wireless signals to enable the computer to communicate with at least one device in a wireless network, and a miniport driver comprising a hardware interface adapted to communicate with the radio, provide control signals to the radio, and/or receive information regarding wireless signals received by the radio from at least one device via a wireless network. The method comprises an act of: (A) providing an interface enabling the operating system to invoke functionality implemented by the miniport driver and/or the radio, the functionality relating to enabling the computer to maintain simultaneous connections with at least two wireless networks using the radio.

Still other embodiments of the invention provide at least one computer storage medium encoded with instructions which, when executed, perform a method, the method for use in a computer comprising an operating system, a radio operable to send and receive wireless signals to enable the computer to communicate with at least one device in a wireless network, and a miniport driver comprising a hardware interface adapted to communicate with the radio, provide control signals to the radio, and/or receive information regarding wireless signals received by the radio from at least one device via a wireless network. The method comprises an act of: (A) providing an interface enabling the operating system to invoke functionality implemented by the miniport driver and/or radio, the functionality relating to enabling the computer to act as an access point for a wireless network.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting an example architecture in which some embodiments of the invention may be implemented;

FIG. 2 is a block diagram depicting an example architecture in which an interface implemented to enable virtualization may be implemented, in accordance with some embodiments of the invention;

FIG. 3 is a sequence diagram depicting example interactions between operating system, interface and miniport driver components to enable virtualization, in accordance with some embodiments of the invention;

FIG. 4 is a block diagram depicting an example topology in scenarios wherein a computer operates as an access point, in accordance with some embodiments of the invention;

FIG. 5 is a block diagram depicting an example architecture in which an interface implemented to facilitate software-enabled access point functionality may be implemented, in accordance with some embodiments of the invention;

FIG. 6 is a sequence diagram depicting example interactions between operating system, interface and miniport driver components to enable a network scan, in accordance with some embodiments of the invention;

FIG. 7 is a sequence diagram depicting example interactions between operating system, interface and miniport driver components to facilitate software-enabled access point functionality to be instantiated, in accordance with some embodiments of the invention;

FIG. 8 is a sequence diagram depicting example interactions between interface and miniport driver components to enable a computer to handle incoming network probe requests, in accordance with some embodiments of the invention;

FIG. 9 is a flowchart depicting an example process for processing an association request from a wireless device, in accordance with some embodiments of the invention;

FIG. 10 is a block diagram depicting an example computer which may be employed to implements some aspects of the invention; and

FIG. 11 is a block diagram depicting an example computer memory on which programmed instructions for implementing aspects of the invention may be stored.

### DETAILED DESCRIPTION

Some embodiments of the invention provide an interface between an operating system and/or other programmed instructions executing on a computer and a miniport driver configured and arranged to communicate with radio hardware, provide control signals to radio hardware, and/or receive information regarding wireless signals received by radio hardware from one or more wireless networks. The interface may enable the operating system and/or other programmed instructions executing on the computer to invoke functionality (e.g., on a user's behalf) implemented by the miniport driver and/or radio hardware so that the computer may employ the functionality. Functionality may, for example, include a capability whereby the computer maintains simultaneous connections on a plurality of wireless networks using a single radio (hereinafter referred to for convenience as “virtualization”), and/or whereby the computer functions as an access point to a wireless network (hereinafter referred to for convenience as “software-enabled access point functionality”). Other functionality may also, or alternatively, be supported, as embodiments of the invention are not limited in this respect.

An interface implemented in accordance with some embodiments of the invention may issue a call to a function or feature implemented by a miniport driver and/or radio hardware using one or more OIDs. As described above, an OID may, for example, be employed by the interface to query information accessible to a miniport driver, set certain variables or other information used by a miniport driver or underlying radio hardware (e.g., in transmitting or receiving data via one or more wireless networks), and/or perform other functions.

The sections that follow describe examples wherein OIDs are used to enable virtualization and software-enabled access point functionality, respectively. However, it should be appreciated that the techniques and components described below for implementing various functions relating to wireless connectivity are intended to be merely illustrative and not limiting.

### I. Virtualization

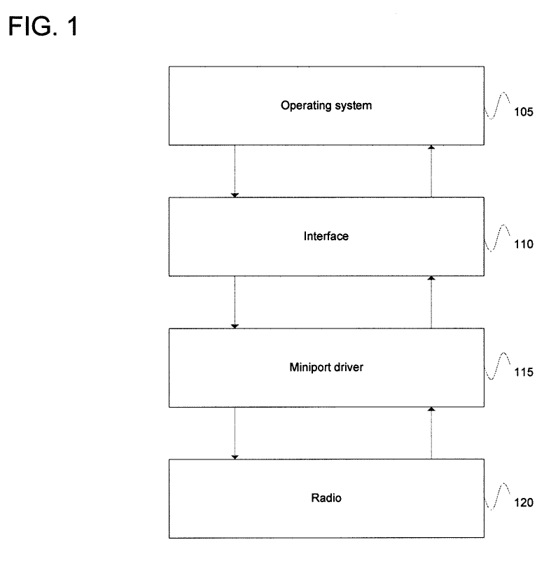

FIG. 1 depicts an example overall architecture in which an interface implemented in accordance with embodiments of the invention may be employed. Such an interface may be employed to, for example, invoke functionality relating to virtualization and software-enabled access point capabilities, which functionality may be implemented by, for example, a miniport driver and/or radio hardware.

The components depicted in FIG. 1 may be employed by a computer (not shown in FIG. 1). For example, operating system 105 may include programmed instructions suitable for execution by the computer. Miniport driver 115 may include programmed instructions, also executable by the computer, through which operating system 105 may communicate with radio 120. For example, miniport driver may provide control signals to radio 120 in response to requests issued by operating system 105, and provide information received by radio 120 via one or more wireless networks to operating system 105.

In accordance with some embodiments of the invention, interface 110 may include various components configured to enable communication between operating system 105 and miniport driver 115. For example, the various components implemented by interface 110 may enable operating system 105 to issue calls to various functions provided by miniport driver 115 and/or radio 120, such as to enable virtualization and/or software-enabled access point functionality (as described in Section II. below).

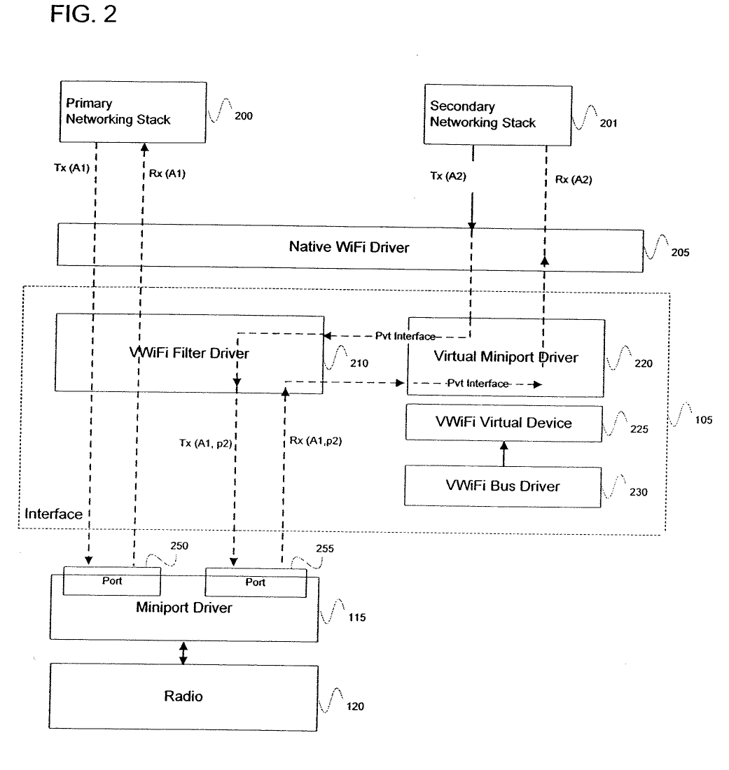

FIG. 2 depicts example components which may be implemented by interface 110 to enable virtualization. FIG. 2 also depicts various interactions between interface components, the operating system and miniport driver to enable the operating system to communicate via a plurality of wireless networks corresponding to ports presented by a miniport driver, in accordance with some embodiments of the invention. In the example of FIG. 2, several components have names which include a reference to “WiFi,” which those skilled in the art will recognize connotes wireless communication employing the IEEE 802.11 standard. However, it should be appreciated that embodiments of the invention are not limited to being implemented in wireless networks that employ the 802.11 standard, and may be implemented in networks which employ any suitable communication standard or protocol, or combination thereof. For example, embodiments of the invention could be employed in networks which employ the WIMAX standard (i.e., using the IEEE 802.16 standard), and/or any other technology or standard(s), whether now known or later developed.

In the example of FIG. 2, interface 110 implements virtual WiFi filter driver 210, virtual miniport driver 220, virtual WiFi virtual device 225 and virtual WiFi bus driver 230. Miniport driver 115 exposes two ports 250, 255 to operating system 105, which employs primary networking stack 200 and secondary networking stack 201 to send and receive information via ports 250 and 255, respectively, and native WiFi driver 205, which is a kernel mode component of operating system 105 used conventionally to pass information (e.g., commands) to miniport driver 115.

In some embodiments, when virtualization is initialized on the computer on which the components of FIG. 2 are implemented, virtual WiFi filter driver 210 is installed “between” operating system 105 and miniport driver 115, such that virtual WiFi filter driver 210 is employed to pass information and/or instructions from operating system 105 to miniport driver 115 and vice versa. For example, virtual WiFi filter driver 210 may be used to pass information from primary networking stack 200 to port 250 provided by miniport driver 115, and vice versa, and to pass information from secondary stack 201 to port 255 provided by miniport driver 115, and vice versa. Virtual WiFi filter driver 210 causes the creation of virtual WiFi device 225, which is a virtual device representation to which operating system 105 directs communication from secondary networking stack 201 to employ secondary port 255. Virtual WiFi bus driver 130 is used to indicate the presence of virtual WiFi device 125 on the software bus (not shown).

Virtual miniport driver 220 is installed between secondary networking stack 201 and virtual WiFi device 225, and receives information from the secondary networking stack intended for virtual WiFi device 225. Virtual miniport driver 220 shares a private interface 212 with virtual WiFi filter driver 210, which is employed to pass information to and receive information from virtual WiFi filter driver 210. As discussed further below, the information passed from virtual miniport driver 220 to virtual WiFi filter driver 210 may include OIDs to call various functions implemented by miniport driver 115 and/or radio 120. Information received from virtual WiFi filter driver 210 may include indications of received packets and various status indications. Virtual miniport driver 120 may pass indications of received packets to secondary networking stack 201.

In the arrangement shown in FIG. 2, virtual WiFi filter driver 210 receives communications from primary and secondary networking stacks 200, 201, and passes these communications to ports 250, 255, respectively, on miniport driver 215. In the example shown, A1 is the primary “device” and A2 is the secondary “device” exposed to operating system 105. Operating system 105 uses primary and secondary networking stacks 200 and 201, respectively, to access primary and secondary devices A1 and A2.

In this example, miniport driver 215 presents port 250 for use by device A1 and port 255 for use by device A2. When operating system 105 attempts communication using device A2, virtual WiFi miniport driver 220 sends the communication to virtual WiFi filter driver 210, which routes them to device A1 on port 255. Any information received on port 255 is routed to virtual WiFi miniport driver 220, which then forwards it to secondary networking stack 201. The result is that the operating system “sees” two devices A1 and A2 which it may use to send and receive information on corresponding wireless networks presented by interface 110, but only a single radio is employed.

It should be appreciated that because interface 110 implements components allowing the operating system to employ multiple devices to simultaneously connect with respective wireless networks, other components shown in FIG. 2, such as the operating system and various networking components implemented thereby, need not be modified to enable virtualization-related functionality. Indeed, many components need not even be aware that a virtualization capability is provided.

In some embodiments, virtual WiFi filter driver 210 is implemented as a modifying filter driver. In this respect, in accordance with aspects of NDIS, a filter driver may reside between two other drivers (in this example, native WiFi driver 206 and miniport driver 115). An NDIS filter driver may be modifying or non-modifying. A non-modifying filter driver is capable only of passing packets received from a first driver in a stack (e.g., the native WiFi driver) to a second driver in the stack (e.g., the miniport driver), and does not “inject” packets into the stack (i.e., pass packets to the second driver in the stack which were not received from the first driver in the stack). A modifying filter driver is capable of injecting packets, and may also be capable of consuming packets (e.g., not passing packets received from the native WiFi driver to the miniport driver).

For example, in the arrangement of FIG. 2, virtual WiFi filter driver 210 forwards packets from virtual WiFi miniport driver 220 to miniport driver 215, and more particularly to port 255. From the perspective of the operating system, virtual WiFi filter driver 210 is injecting packets into the stack (e.g., Tx (A1, P2) packet did not originate from the primary stack 200 used by the operating system). Similarly, when information is received, the operating system perceives that the information is passed from miniport driver 115 to virtual WiFi filter driver 210, but is not then passed up the primary stack 200 (e.g., Rx (A1, P2) is not passed up to primary networking stack 200). Thus, virtual WiFi filter driver 210 appears to the operating system to have consumed these packets.

Of course, virtual WiFi filter driver 210 need not be implemented via a filter driver, whether modifying or non-modifying, and may be implemented in any suitable fashion, using any one or more software and/or hardware components. In this respect, all of the components of interface 110 shown in FIG. 2 may be implemented using any suitable combination of hardware and/or software components, as the invention is not limited to being implemented in any particular manner.

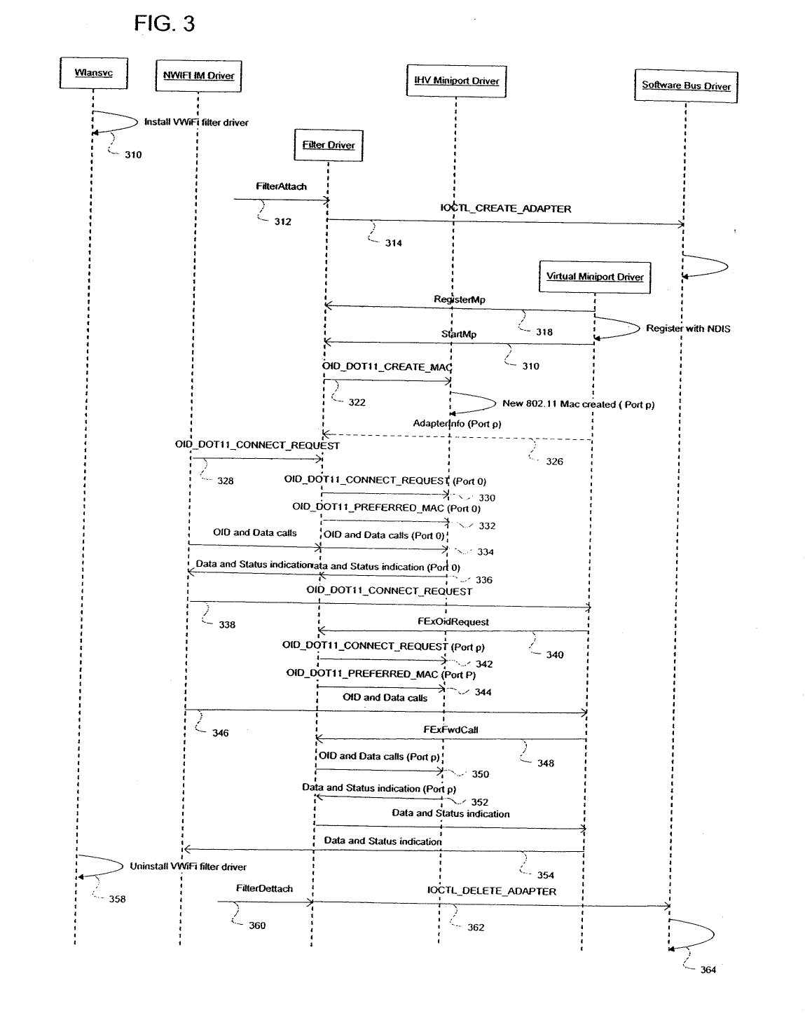

FIG. 3 is a sequence diagram depicting example interactions between these and other components to enable virtualization-related functions. In particular, FIG. 3 depicts interactions between wireless LAN service 300, native WiFi driver 206, virtual WiFi filter driver 210, miniport driver 215, virtual miniport driver 220 and software bus driver 305.

Wireless LAN service (Wlansvc) 300 is a user mode operating system component capable of accepting user commands to enable virtualization. As described above, native WiFi driver (NWIFI IM driver) 205 is a kernel mode operating system component used conventionally to pass information to miniport driver 215. Once virtualization is enabled, virtual WiFi filter driver (filter driver) 210 is installed, and issues calls to miniport driver (IHV miniport driver) 215 to invoke virtualization-related functions. In some embodiments described below, virtual WiFi filter driver 210 may pass various OIDs to miniport driver 215.

At the start of the sequence depicted in FIG. 3, wireless LAN service 300 receives instructions (e.g., from a user, application, etc.) to enable virtualization. When this occurs, wireless LAN service 300 installs virtual WiFi filter driver 210 in act 310. A stack is then built for virtual WiFi filter driver 210, and virtual WiFi filter driver is attached to the stack in act 312. Virtual WiFi filter driver 210 now sits “on top of” miniport driver 215, and can communicate with (e.g., by sending commands to) miniport driver 215.

In act 314, virtual WiFi filter driver 210 issues an IOCTL_CREATE_ADAPTER request to software bus driver 305 to create a new virtual device (e.g., virtual WiFi device 225, FIG. 2). Software bus driver 305 processes this command in act 316, thereby creating virtual miniport driver 220. Virtual miniport driver 220 is then registered with filter driver 210 in act 318 and started in act 320.

In act 322, virtual WiFi filter driver 210 calls miniport driver 215 to create a new port, in the form of a new media access control (MAC) context. In the embodiment shown, virtual WiFi filter driver 210 does this using an OID (in particular, OID_DOT11_CREATE_MAC). In one example, the data associated with OID_DOT11_CREATE_MAC is defined as represented in Table 1 below.

TABLE 1

```
Definition
#define DOT11_MAC_INFO_REVISION_1 1
typedef struct _DOT11_MAC_INFO {
      NDIS_OBJECT_HEADER Header;
    ULONG uNdisPortNumber;
} DOT11_MAC_INFO, * P DOT11_MAC_INFO;
wherein Header:
    Type == NDIS_OBJECT_TYPE_DEFAULT
    Revision == DOT11_MAC_INFO_REVISION_1
    Size == sizeof(DOT11_MAC_INFO)
uNdisPortNumber: NDIS port number used to reference the newly
created MAC entity.
```

OID_DOT11_CREATE_MAC may be employed to request that an entity (in the example of FIG. 3, miniport driver 215) instantiate a new 802.11 MAC entity. When this occurs, the miniport may return a DOT11_MAC_INFO structure back, in which the miniport assigns a port number to the port it has created.

In some embodiments, if the miniport has already created the maximum number of MAC entities it can support, it may respond with a failure indication, such as by calling an NDIS function to indicate that a failure has occurred.

Returning to FIG. 3, miniport driver 215 creates the new MAC state in act 324. In act 326, virtual miniport driver 220 provides information relating to the newly created MAC state to virtual WiFi filter driver 210.

In act 328, native WiFi driver 205 requests that virtual WiFi filter driver 210 establish a connection. In the example shown, this is done using an OID (in particular, OID_DOT11_CONNECT_REQUEST). Virtual WiFi filter driver 210 then sends the OID to miniport driver 215, specifying that the connection should occur on port 0, which in this example represents the MAC context created in act 324. In some embodiments, a MAC context may be defined at least in part by a MAC address which is unique from MAC addresses associated with other ports associated with a respective wireless network, although other settings (e.g., data rate, channel, security algorithm employed, etc.) may also define a MAC context.

In act 332, virtual WiFi filter driver 210 and also specifies using OID_DOT11_PREFERRED_MAC that port 0 (specified for the connection) is the preferred MAC state. In this respect, in some embodiments, virtual WiFi filter driver 210 may specify a preferred order of MAC states to the miniport driver, so that the miniport driver may make decisions about which connection(s) to drop in case it can not sustain all connections simultaneously. The data associated with OID_DOT11_PREFERRED_MAC may, for example, be defined as represented below in Table 2.

```
TABLE 2
Definition
#define DOT11_{—} MAC_PREFERRED_ORDER _REVISION_1 1
typedef struct DOT11_{—} MAC_PREFERRED_ORDER {
  NDIS_OBJECT_HEADER Header;
  ULONG uTotalNumOfEntries;
#ifdef _{——}midl
  [unique, size_is(uTotalNumOfEntries)] DOT11_MAC_INFO
  PreferredOrderList[*];
#else
  DOT11_MAC_INFO PreferredOrderList [1];
#endif
} DOT11_{—} MAC_PREFERRED_ORDER,
*PDOT11_{—} MAC_PREFERRED_ORDER;
wherein Header:
      Type == NDIS_OBJECT_TYPE_DEFAULT
      Revision ==
      DOT11_MAC_PREFERRED_ORDER _REVISION_1
      Size == sizeof(DOT11_{—} MAC_PREFERRED_ORDER)
uTotalNumOfEntries: total number of DOT11_MAC_INFO structures
PreferredOrderList: MAC preferences in descending order
```

OID_DOT11_PREFERRED_MAC may be used to establish MAC state preferences in descending order. For example, a preferred order list may include a most specified MAC state as a first entry and other, less preferred MAC states in descending order. This OID may be used to inform miniport driver 115 of the preferred order for previously created MAC entities, so that if miniport driver is forced to make decisions about dropping connections in case it can not sustain all of them simultaneously, it may use the preferred order to make these decisions.

The sequence of FIG. 3 then proceeds to act 334, wherein native WiFi driver 205 employs port 0 for OID and data calls. In act 336, miniport driver 215 provides data and status indications via port 0 to native WiFi driver 205.

In act 338, native WiFi driver 205 requests a second connection by again passing OID_DOT11_CONNECT_REQUEST to virtual miniport driver 220, which then passes the request to virtual WiFi filter driver 210 in act 340. In act 342, virtual WiFi filter driver 210 passes the OID to miniport driver 115, specifying that the connection should be on port p. Virtual WiFi filter driver 210 also passes OID_DOT11_PREFERRED_MAC to indicate that port p should thereafter be the preferred port to miniport driver 215 in act 344.

Thereafter, native WiFi driver 205 passes OID and data calls to virtual miniport driver 220 in act 346, which virtual miniport driver 220 then passes to virtual WiFi filter driver 210 in act 348. Virtual WiFi driver 210 then passes these OID and data call on port p to miniport driver 215, which then passes data and status indications via port p to virtual WiFi filter driver 210 in act 352. Virtual WiFi filter driver 210 then passes the data and status indications to virtual miniport driver 220 in act 354, which then passes the data and status indications to native WiFi driver 205 in act 356.

In act 358, a user command is received to disable virtualization. This causes wireless LAN service 300 to uninstall the virtual WiFi filter driver 210 in act 358. The virtual WiFi filter driver is then detached from the stack in act 360, and an instruction to delete the adapter is then issued to software bus driver 305, which deletes the adapter and indicates its removal in act 364. The sequence of FIG. 3 then completes.

It should be appreciated that although the foregoing description relates to an interface which provides capabilities relating to a computer maintaining simultaneous connections on plural wireless networks using a single radio, embodiments of the invention are not so limited. For example, in accordance with some embodiments of the invention, an interface may be employed with multiple radios, accessible via one or more miniport drivers. Embodiments of the invention are not limited to being implemented with any particular radio and/or miniport driver configuration. In addition, embodiments of the invention need not be employed with a radio that includes a single transmitter and receiver. For example, embodiments of the invention might be employed with a radio having either no transmitter or no receiver, or with a radio having a different number of receivers than transmitters (e.g., a hybrid radio having multiple receivers and one transmitter). Embodiments of the invention are not limited to being implemented with any particular hardware and/or software configuration.

Section II below describes an example interface which may be employed in relation to software-enabled access point functionality.

### II. Software-Enabled Access Point Functionality

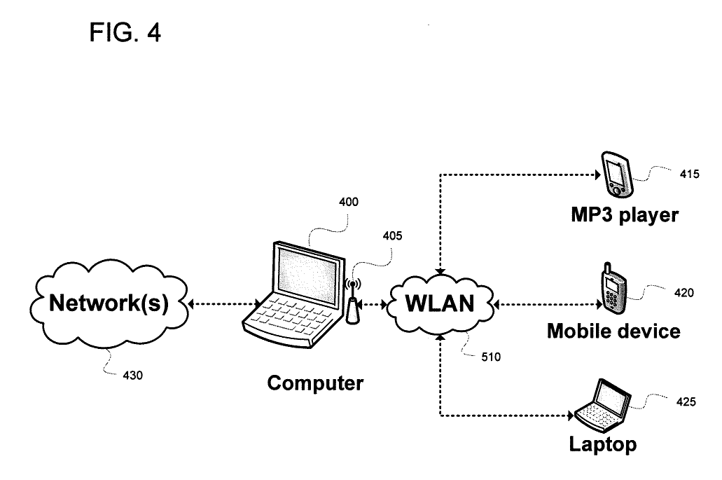

FIG. 4 illustrates an example connectivity scenario in which a computer 400 employs software-enabled access point functionality. In this scenario, a radio 405 on computer 400 is enabled via software to allow computer 400 to perform as a wireless access point. As such, each of devices 415, 420, 425 are able to connect to computer 400 via radio 405 and wireless LAN 410. As such, any of these devices may access services and/or files on computer 400 itself (e.g., to synchronize data (e.g., music files) stored on a device and the computer) and/or connect to another network 430 to which computer 400 is connected, such as the Internet. Thus, a user of any of devices 415, 420, 425 (and/or other devices) may employ various network-accessible services, such as those enabling calendar synchronization (e.g., to synchronize the calendar maintained on mobile wireless device 420), music download (e.g., using MP3 player 415 or laptop 425), and/or any of numerous other services.

An interface implemented between a computer's operating system and a miniport driver may enable the operating system to invoke functionality implemented by the miniport driver and/or radio to enable the computer to perform as a wireless access point. For example, a user may cause a request to be issued (e.g., using an application, a command line provided by the operating system, and/or any other suitable vehicle(s)) to enable the computer to function as a wireless access point, and the request may be passed from the computer's operating system via an interface implemented in accordance with embodiments of the invention to a miniport driver, causing functionality implemented by the miniport driver and/or radio hardware with which it communicates to be invoked. As with the embodiments of the invention described in Section I. above, an interface may, for example, provide a set of guidelines and rules allowing an operating system to issue calls to functions implemented by a miniport driver and/or radio hardware, and/or allowing the miniport driver and/or radio hardware to provide information to the operating system, using OIDs or any other suitable vehicle(s) and/or technique(s).

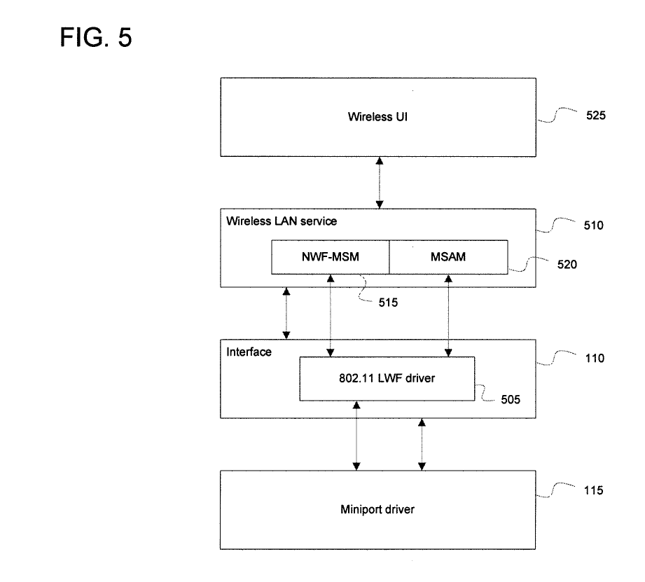

FIG. 5 describes various components provided by an interface implemented in accordance with embodiments of the invention, as well as operating system and miniport driver modules with which these components interact. As with FIG. 2 described above, several components in FIG. 5 have names which suggest an implementation in a wireless network which employs the IEEE 802.11 standard (e.g., 802.11 driver, wireless LAN service, etc.). However, it should be appreciated that the invention is not limited to being implemented in wireless networks which employ the 802.11 standard, and may be implemented in wireless networks that employ any suitable communication standard(s), protocol(s), or combination(s) thereof, whether now known or later developed.

The configuration of FIG. 5 includes miniport driver 115, which, as is described above, is a component comprising a hardware interface adapted to communicate with radio hardware, provide control signals to radio hardware, and/or receive information regarding wireless signals received by radio hardware from one or more wireless networks. Operating system 105 communicates with miniport driver 115 via interface 110. Operating system 105 includes 802.11 lightweight filter driver (LWF driver) 505 and wireless LAN service 510, which is a user mode component that includes Native WiFi Media Specific Module (NWF-MSM) 515 and Media Specific Access Point Module 520. In accordance with some embodiments, various components of operating system 105 may issue calls to miniport driver 115 via interface 110 relating to software-enabled access point functionality, including initiating and stopping access point capability at the user's request. For example, in accordance with some embodiments, interface 110 passes one or more OIDs to miniport driver 115 to enable software-enabled access point functionality.

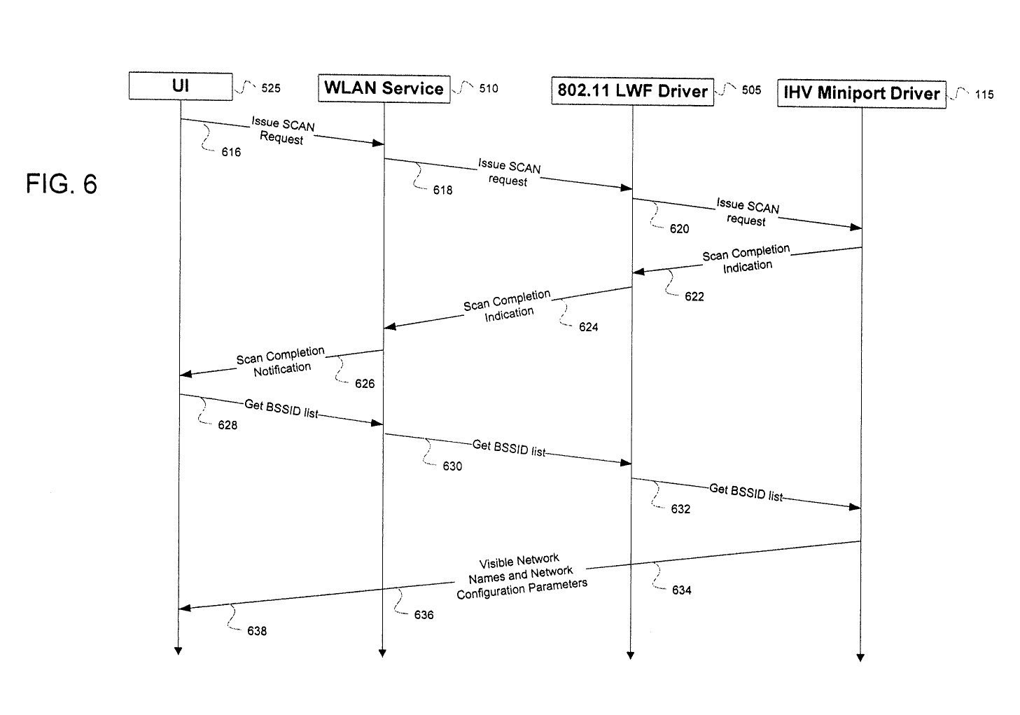

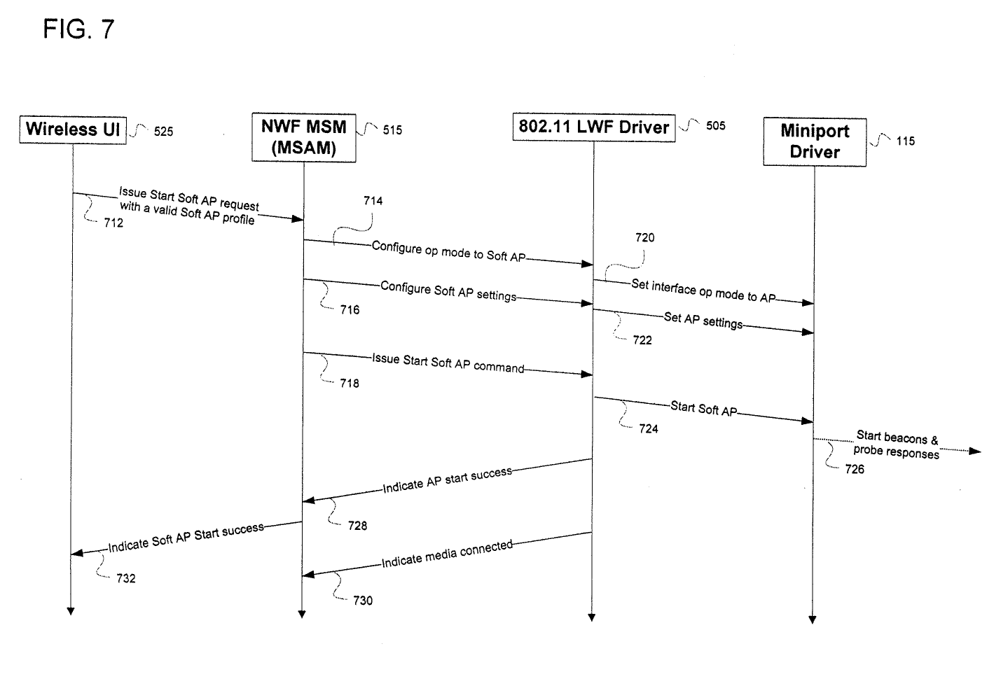

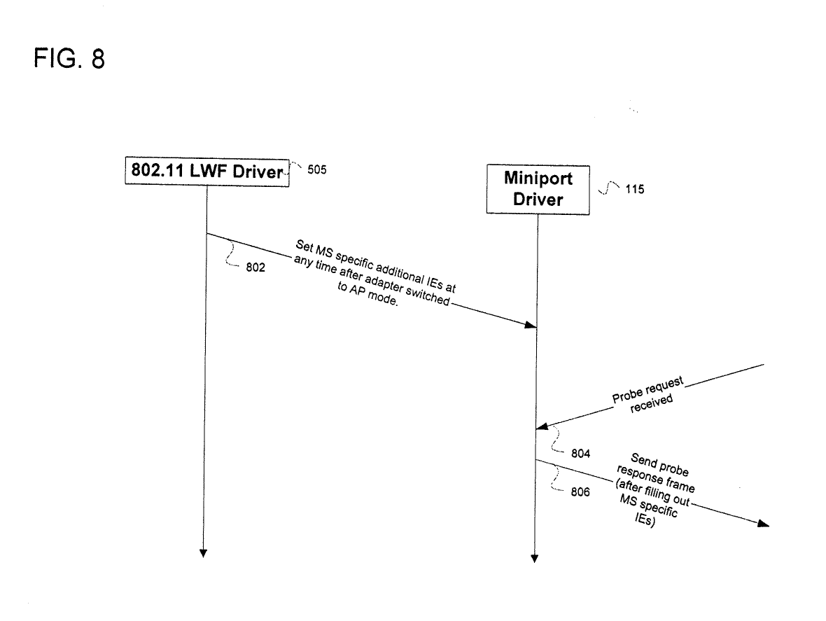

FIGS. 6-8 depict example interactions between components depicted in FIG. 5 to enable functionality relating to software-enabled access point capabilities. For example, FIG. 6 depicts example component interactions to perform a network scan, FIG. 7 depicts example component interactions to instantiate a network access point profile, and FIG. 8 depicts example component interactions to handle probe request packets received from other devices. In each of these example interactions, interface 110 is used to pass one or more OIDs from a component of operating system 105 to miniport driver 115.

FIG. 6 is a sequence diagram depicting example component interactions to perform a network scan, such as to identify devices with which a connection might be established. In the sequence depicted in FIG. 6, wireless UI 525 issues a scan request to wireless LAN service 510, which then transmits the request to 802.11 LWF driver 505. 802.11 LWF driver then passes the request to miniport driver 115 in the form of an OID, called OID_DOT11_SCAN_REQUEST.

After receiving the OID from 802.11 LWF driver 505, miniport driver 115 may employ proprietary logic to cause radio hardware to perform a network scan. For example, radio hardware may be caused to disengage from any active communication then ongoing and listen to all channels for traffic, or to send out probes requesting a reply from surrounding access points or nodes, or to employ any other suitable technique(s) to perform a scan.

In act 622, after the network scan has been completed, miniport driver 115 transmits an indication of completion to 802.11 LWF driver 505. 802.11 LWF driver 505 passes the indication to wireless LAN service 510 in act 624, and in act 626, wireless LAN service 510 notifies wireless UI 615 that the scan has been completed.

Acts 628-638 represent optional actions to retrieve a list of identifiers for access points to which stations may establish a connection. In this example, a list of basic service set identifiers (BSSIDs) is retrieved. In act 628, wireless UI 525 issues a request to get a BSS ID list to wireless LAN service 510, which then passes the request to 802.11 LWF driver 505 in act 630. 802.11 LWF driver 505 then passes the request to miniport driver 215 in act 632 using an OID called OID_DOT11_ENUM_BSS_LIST.

Miniport driver 115 may then employ proprietary logic to retrieve a list of BSS IDs. After retrieval is performed, a list of visible network names and network configuration parameters is passed from miniport driver 115 to 802.11 LWF driver 505 in act 634, which then passes the list to wireless LAN service 510 in act 636. The list is then passed to wireless UI 525 in act 638. The sequence of FIG. 6 then completes.

FIG. 7 depicts an example sequence through which miniport driver 115 may be instructed to instantiate a software access point profile. For example, a user may request that his/her computer instantiate an access point profile so that the computer may thereafter function as an access point. In the example of FIG. 7, wireless UI 525 issues a request that access point functionality be started by instantiating an access point profile to wireless LAN service 510 in act 712. Wireless LAN service 510 checks settings for the requested profile and determines that the requested profile is to allow the computer to function as an access point. The wireless LAN service 510 issues requests to 802.11 LWF driver to configure the computer's operational mode to allow it to perform as an access point in act 714, configure various connectivity settings (e.g., SSID common supported data rates, client number limits, layer two security settings, etc.) in act 716 and start software-enabled access point functionality in act 718.

802.11 LWF driver 505 passes these commands, in the form of various OIDs, to miniport driver 115 in acts 720, 722 and 724. In the example shown, the 802.11 LWF driver 505 may employ OID_DOT11_CURRENT_OPERATION_MODE to instruct miniport driver 115 to set the interface to access point operational mode, OID_DOT11_START_AP_REQUEST to start access point functionality, and OIDs such as OID_DOT11_DESIRED_SSID_LIST and OID_DOT11_ENABLED_AUTHENTICATION_ALGORITHM to configure various access point settings.

The data associated with OID_DOT11_CURRENT_OPERATION_MODE may, for example, be defined as represented below in Table 3.

```
TABLE 3
Definition
typedef struct _DOT11_CURRENT_OPERATION_MODE {
  ULONG uReserved;
  ULONG uCurrentOpMode;
} DOT11_CURRENT_OPERATION_MODE, DOT11_CURRENT_OPERATION_MODE;
wherein uReserved: reserved field; the 802.11 framework may set it to zero before the
call; if so, it may remain set to zero when the call completes.
uCurrentOpMode: initially, when the radio boots up, it is in one of the following modes:
  DOT11_OPERATION_MODE_STATION by default, if the radio supports station
  mode; DOT11_OPERATION_MODE_EXTENSIBLE_STATION by default if the
  radio supports extensible station mode and doesn't support station mode; or
  DOT11_OPERATION_MODE_EXTENSIBLE_AP by default if the radio supports
  AP only mode. If the radio runs as a station,
  DOT11_OPERATION_MODE_STATION is used to set it in this mode, if as an
  extensible station, then DOT11_OPERATION_MODE_EXTENSIBLE_STATION
  is used to set it in this mode, or if as an AP,
  DOT11_OPERATION_MODE_EXTENSIBLE_AP is used to set it in this mode.
```

The data associated with OID_DOT11_START_AP_REQUEST may, for example, be defined as represented below in Table 4.

```
TABLE 4
Data Type None
Radio's Operational Behavior on set:
ExtAP INIT state: If the radio cannot perform the start AP request because
  msDot11DesiredPhyList are all turned off, the radio should fail this request with
  NDIS_STATUS_POWER_STATE_INVALID.
The radio may allocate all resources before starting the association procedure. If it
  cannot allocate all resources, it may complete the request using
  NDIS_STATUS_RESOURCES. Otherwise, it may complete the request with
  NDIS_STATUS_SUCCESS. In the latter case, the miniport driver may start the
  access point. After the call is completed, the radio may start sending out beacon
  packet and perform access point functions.
ExtAP OP state: Fail the request with error code NDIS_STATUS_INVALID_STATE.
```

The data associated with OID_DOT11_DESIRED_SSID_LIST may, for example, be defined as represented below in Table 5.

TABLE 5

| Definition | |
|---|---|
| #define DOT11_SSID_LIST_REVISION_1 1 | |
| typedef struct DOT11_SSID_LIST { | |
| NDIS_OBJECT_HEADER Header; | |
| ULONG uNumOfEntries; | |
| ULONG uTotalNumOfEntries; | |
| DOT11_SSID SSIDs[1]; | |
| } DOT11_SSID_LIST, * PDOT11_SSID_LIST; | |
| wherein Header: | |
| Type == NDIS_OBJECT_TYPE_DEFAULT | |
| Revision == DOT11_SSID_LIST_REVISION_1 | |
| Size == sizeof(DOT11_SSID_LIST) | |
| Definition | DOT11_SSID_LIST msDot11DesiredSSIDList; |
| Data Type | DOT11_SSID_LIST |

The data associated with OID_DOT11_ENABLED_AUTHENTICATION_ALGORITHM may, for example, be defined as represented below in Table 6.

```
TABLE 6
Definition
        typedef enum DOT11_AUTH_ALGORITHM {
          DOT11_AUTH_ALGO_80211_OPEN = 1,
          DOT11_AUTH_ALGO_80211_SHARED_KEY,
          DOT11_AUTH_ALGO_WPA,
          DOT11_AUTH_ALGO_WPA_PSK,
          DOT11_AUTH_ALGO_RSNA,
          DOT11_AUTH_ALGO_RSNA_PSK,
          DOT11_AUTH_ALGO_IHV_START = 0x80000000,
          DOT11_AUTH_ALGO_IHV_END = 0xffffffff
        } DOT11_AUTH_ALGORITHM, * PDOT11_AUTH_ALGORITHM;
        #define DOT11_AUTH_ALGORITHM_LIST_REVISION_1 1
        typedef struct DOT11_AUTH_ALGORITHM_LIST {
          NDIS_OBJECT_HEADER Header;
          ULONG uNumOfEntries;
          ULONG uTotalNumOfEntries;
          DOT11_AUTH_ALGORITHM AlgorithmIds[1];
        } DOT11_AUTH_ALGORITHM_LIST, *
        PDOT11_AUTH_ALGORITHM_LIST;
Header:
      Type == NDIS_OBJECT_TYPE_DEFAULT
      Revision == DOT11_AUTH_ALGORITHM_LIST_REVISION_1
      Size == sizeof(DOT11_AUTH_ALGORITHM_LIST)
Definition DOT11_AUTH_ALGORITHM_LIST msDot11EnabledAuthAlgo;
Data Type DOT11_AUTH_ALGORITHM_LIST
      DOT11_AUTH_ALGO_80211_OPEN: 802.11 open system authentication
        algorithm.
      DOT11_AUTH_ALGO_80211_SHARED_KEY: 802.11 shared key
        authentication algorithm.
      DOT11_AUTH_ALGO_WPA: a combination of 802.11 open system
        authentication, port authorization (e.g. 802.1x) and WPA 4-way handshake.
      DOT11_AUTH_ALGO_WPA_PSK: a combination of 802.11 open system
        authentication and WPA 4-way handshake using preshared key.
      DOT11_AUTH_ALGO_RSNA: a combination of 802.11 open system
        authentication, port authorization (e.g. 802.1x) and 802.11i 4-way handshake.
      DOT11_AUTH_ALGO_RSNA_PSK: a combination of 802.11 open system
        authentication and 802.11i 4-way handshake using preshared key.
      When the radio is in ExtAP mode, values between
        DOT11_AUTH_ALGO_IHV_START and DOT11_AUTH_ALGO_IHV_END
        are not applicable and should be ignored.
```

Upon starting access point functionality, miniport driver 115 may begin sending out beacon frames and probe responses, as indicated by the dotted line of act 726.

After access point functionality has been successfully established, 802.11 LWF driver 505 sends an indication to wireless LAN service 510 in act 728. 802.11 LWF driver 505 may also indicates to these components a media connected event in act 730. The wireless LAN service 510 then indicates to wireless UI 525 that access point functionality has been successfully started in act 732.

FIG. 8 depicts an example sequence to second beacon transmissions to and manage probe requests received from other 802.11 devices. In the example shown, 802.11 LWF driver 605 issues a request to set additional IEs in act 802. In some embodiments, this is done using an OID named OID_DOT11_ADDITIONAL_IE. Thereafter, when a probe request is received from one or more other 802.11 devices, miniport driver 115 causes a probe response frame to be sent wherein specific IE's are defined in act 806. Miniport driver 115 may also, or alternatively, send one or more beacon transmissions wherein specific IE's are defined in act 808. The IE's defined in a beacon transmission may be different than those which are specified in a probe response. The data associated with OID_DOT11_ADDITIONAL_IE may, for example, be defined as represented below in Table 7.

```
TABLE 7
Data Type DOT11_ADDITIONAL_IE msDot11AdditionalIEs;
Definition
      #define DOT11_{—} ADDITIONAL_IE_REVISION_1 1
      typedef struct DOT11_ADDITIONAL_IE {
        NDIS_OBJECT_HEADER Header;
        ULONG uBeaconIEsOffset;
        ULONG uBeaconIEsLength;
        ULONG uResponseIEsOffset;
        ULONG uResponseIEsLength;
      } DOT11_ADDITIONAL_IE, * PDOT11_ADDITIONAL_IE;
Header:
      Type == NDIS_OBJECT_TYPE_DEFAULT
      Revision == DOT11_ADDITIONAL_IE _REVISION_1
      Size == sizeof(DOT11_ADDITIONAL_IE)
uIEsOffset and uIEsLength:
      Offset may be calculated from the beginning of DOT11_ADDITIONAL_IE.
            uBeaconIEsOffset and uBeaconIEsLength define additional IEs for
            beacons, and uResponseIEsOffset and uResponseIEsLength define
            additional IEs for probe responses.
```

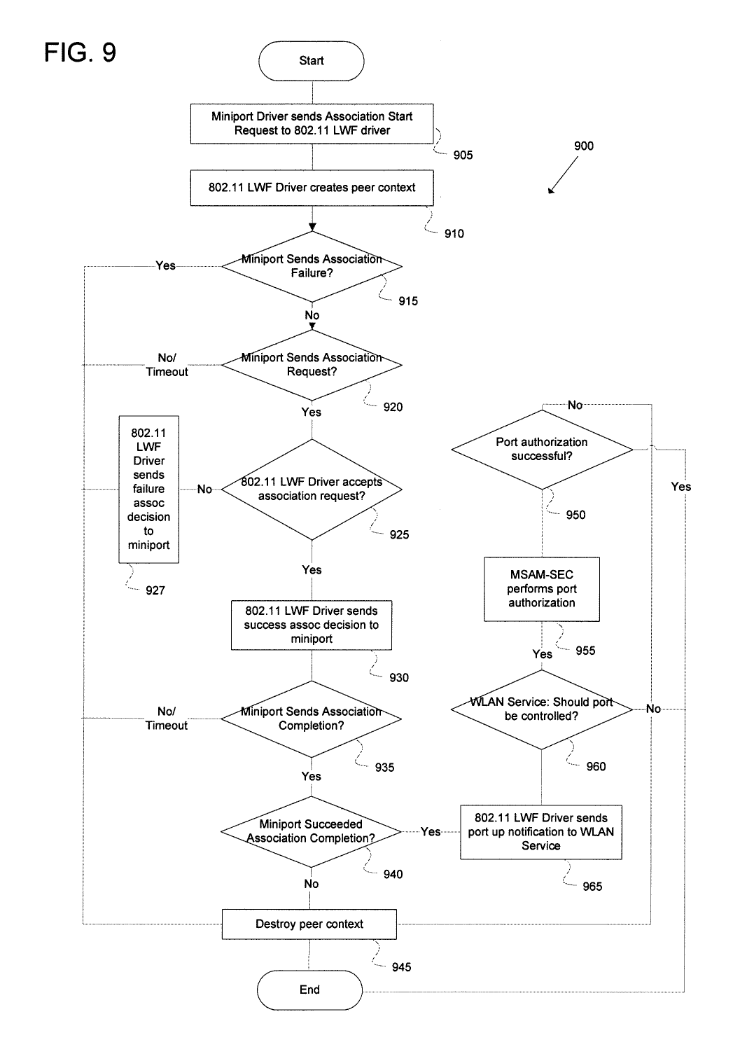

FIG. 9 depicts an example process 900 for processing association requests from a wireless device (e.g., using the 802.11 standard). Upon the start of process 900, miniport driver 115 sends an association start request to 802.11 LWF driver 605 in act 905. In some embodiments, miniport driver 115 sends this request using an OID named NDIS_STATUS_DOT11_INCOMING_ASSOC_STARTED. The data associated with OID_DOT11_INCOMING_ASSOC_STARTED may, for example, be defined as represented below in Table 8.

```
TABLE 8
Definition
#define DOT11_INCOMING_ASSOC_STARTED_PARAMETERS_REVISION_1 1
typedef struct DOT11_INCOMING_ASSOC_STARTED_PARAMETERS {
  NDIS_OBJECT_HEADER Header;
  DOT11_MAC_ADDRESS MacAddr;
} DOT11_INCOMING_ASSOC_STARTED_PARAMETERS,
* PDOT11_INCOMING_ASSOC_STARTED_PARAMETERS;
Header:
      Type == NDIS_OBJECT_TYPE_DEFAULT
      Revision == DOT11_ASSOCIATION_START_PARAMETERS_REVISION_1
      Size == sizeof(DOT11_ASSOCIATION_START_PARAMETERS)
MacAddr: the MAC address of the station from which the authentication request was
      received.
```

Process 900 then proceeds to act 910, wherein 802.11 LWF driver then creates a context for the association.

The process then proceeds to act 915, wherein a determination is made whether the miniport sends an association failure indication. If not, process 900 proceeds to act 920. If so, process 900 proceeds to act 945, wherein the context is destroyed, and process 900 completes.

In act 920, a determination is made whether miniport 115 sends an association request. In some embodiments, miniport 115 may send an association request using an OID named NDIS_STATUS_DOT11_INCOMING_ASSOC_REQUEST_RECEIVED.

The data associated with NDIS_STATUS_DOT11_INCOMING_ASSOC_REQUEST_RECEIVED may, for example, be defined as represented below in Table 9.

```
TABLE 9
Definition
#define
DOT11_INCOMING_ASSOC_REQUEST_RECEIVED_PARAMETERS_REVISION_1 1
typedef struct
_DOT11_INCOMING_ASSOC_REQUEST_RECEIVED_PARAMETERS {
  NDIS_OBJECT_HEADER Header;
  DOT11_MAC_ADDRESS MacAddr;
  BOOLEAN bReAssocReq;
  ULONG uAssocReqOffset;
  ULONG uAssocReqSize;
} DOT11_INCOMING_ASSOC_REQUEST_RECEIVED_PARAMETERS,
  * PDOT11_INCOMING_ASSOC_REQUEST_RECEIVED_PARAMETERS;
Header:
      Type == NDIS_OBJECT_TYPE_DEFAULT
      Revision == DOT11_{—} INCOMING_ASSOCIATION_REQUEST_{—} REVISION_1
      Size == sizeof(DOT11_{—} INCOMING_ASSOCIATION_REQUEST)
MacAddr: MAC address of a peer station in the selected ad hoc network or the MAC
      address of an AP in the selected infrastructure network.
bReAssocReq: True if the request is for re-association.
uAssocReqOffset and uAssocReqSize: uAssocReqOffset and uAssocReqSize are offset
      and size of the association request frame (when bReAssocReq is FALSE) or
      reassociation request (when bReAssocReq is TRUE). The frame does not include
      the MAC header. Association request and Reassociation request frame format is
      defined in ISO/IEC 8802-11. uAssocReqSize is represented as a number of
      bytes.
```

If it is determined in act 920 that miniport 115 does not send an association request, or if the request has timed out, process 900 proceeds to act 945, wherein the context is destroyed and process 900 completes. If so, the process proceeds to act 925, wherein it is determined whether the 802.11 LWF driver 505 accepts the association request. If not, 802.11 LWF driver 505 sends a failure decision to miniport 115 in act 927, and process 900 proceeds to act 945, wherein the context is destroyed. Process 900 then completes.

If 802.11 LWF driver 505 accepts the association request in act 925, process 900 proceeds to act 930, wherein 802.11 LWF driver 505 sends a success decision to miniport 115. In some embodiments, a success decision may be sent to miniport 115 using an OID named OID_DOT11_INCOMING_ASSOCIATION_DECISION. The data associated with OID_DOT11_INCOMING_ASSOCIATION_DECISION may, for example, be defined as represented below in Table 10.

```
TABLE 10
Definition
      #define DOT11_INCOMING_ASSOC_DECISION_REVISION_1 1
      typedef struct DOT11_INCOMING_ASSOC_RESPONSE_DECISION {
        NDIS_OBJECT_HEADER Header;
        DOT11_MAC_ADDRESS PeerMacAddr;
        BOOLEAN bAccept;
        USHORT usReasonCode;
      } DOT11_INCOMING_ASSOC_DECISION,
      *PDOT11_INCOMING_ASSOC_DECISION;
Header:
      Type == NDIS_OBJECT_TYPE_DEFAULT
      Revision ==
            DOT11_INCOMING_ASSOC_DECISION_RESPONSE_REVISION_1
      Size == sizeof(DOT11_INCOMING_ASSOC_RESPONSE_DECISION)
pDot11AssocRequest: pointer to
      DOT11_INCOMING_ASSOC_REQUEST_RECEIVED data structure in
      NDIS_STATUS_DOT11_STATUS_ASSOCIATION_REQUEST_RECEIVED
      indication.
bAccept: TRUE if the radio should accept the corresponding incoming assocation
      request; FALSE if the radio should reject to the corresponding incoming
      association request.
usReasonCode: code to include in the corresponding association response if the
      incoming association request is rejected.
```

Process 900 then proceeds to act 935, wherein it is determined whether miniport 115 sends an association completion. In some embodiments, miniport 115 may send an association completion using an OID named NDIS_STATUS_DOT11_INCOMING_ASSOC_COMPLETION. The data associated with NDIS_STATUS_DOT11_INCOMING_ASSOC_COMPLETION may, for example, be defined as represented below in Table 11.

```
TABLE 11
Definition
#define
DOT11_INCOMING_ASSOC_COMPLETION_PARAMETERS_REVISION_1 1
typedef struct DOT11_INCOMING_ASSOC_COMPLETION_PARAMETERS {
  NDIS_OBJECT_HEADER Header;
  DOT11_MAC_ADDRESS MacAddr;
  ULONG uStatus;
  UCHAR ucErrorSource;
  BOOLEAN bReAssocReq;
  BOOLEAN bReAssocResp;
  ULONG uAssocReqOffset, uAssocReqSize;
  ULONG uAssocRespOffset, uAssocRespSize;
  // The following fields are applicable for successful association.
  // For association failure, they must be zero-ed out.
  DOT11_AUTH_ALGORITHM AuthAlgo;
  DOT11_CIPHER_ALGORITHM UnicastCipher;
  DOT11_CIPHER_ALGORITHM MulticastCipher;
  ULONG uActivePhyListOffset, uActivePhyListSize;
} DOT11_INCOMING_ASSOC_COMPLETION_PARAMETERS,
* PDOT11_INCOMING_ASSOC_COMPLETION_PARAMETERS;
Header:
      Type == NDIS_OBJECT_TYPE_DEFAULT
      Revision ==
            DOT11_INCOMING_ASSOC_COMPLETION_PARAMETERS_REVISION_1
      Size ==
            sizeof(DOT11_INCOMING_ASSOC_COMPLETION_PARAMETERS)
MacAddr: the MAC address of the station from which the association request was
      received.
uStatus and ucErrorSource: uStatus indicates the status of the association. A zero value
      indicates a successful association. A non-zero value indicates that the association
      failed.
When uStatus is set to non-zero, the interpretation of uStatus depends on the value of
      ucErrorSource. The NIC must also set the ucErrorSource to indicate the source of
      the errors. Currently, three sources are defined:
```

| | |
|---|---|
| #define DOT11_ASSOC_ERROR_SOURCE_OS | 0 |
| #define DOT11_ASSOC_ERROR_SOURCE_REMOTE | 1 |
| #define DOT11_ASSOC_ERROR_SOURCE_OTHER | 255 |

```
DOT11_ASSOC_ERROR_SOURCE_OS may be used if miniport aborts the association
      procedure because of OS errors, such as out of memory. In this case, uStatus field
      should contain the NDIS_STATUS code or NTSTATUS code returned from the
      OS API.
DOT11_ASSOC_ERROR_SOURCE_REMOTE may be used if the association is
      rejected by the AP or the peer station. In this case, the uStatus field contains the
      802.11 status code from the 802.11 authentication frame or the 802.11
      (re)association response frame. Table 19 in the IEEE 802.11-2003 spec contains
      all the possible values. When IEEE 802.11 spec is amended and/or new values
      are added, miniport driver can also return those values.
DOT11_ASSOC_ERROR_SOURCE_OTHER can be used if the association is failed
      due to an IHV specific reason. In this case, the uStatus contains an non-zero IHV
      specific value.
```

If it is determined in act 935 that miniport 115 does not send an association completion, process 900 proceeds to act 945, wherein the context is destroyed. Process 900 then completes.

If it is determined in act 935 that miniport 115 sends an association completion, process 900 proceeds to act 940, wherein it is determined whether miniport 115 successfully completed the association. If not, process 900 proceeds to act 945, wherein the context is destroyed, and process 900 then completes. If it is determined in act 940 that miniport 115 successfully completed the association, process 900 proceeds to act 965, wherein 802.11 LWF driver 505 sends a “port up” notification to wireless LAN service 510.

Process 900 then proceeds to act 960, wherein a determination is made whether wireless LAN service 510 should control the port. If not, process 900 completes. If so, process 900 proceeds to act 955, wherein MSAM 520 performs port authorization. Process 900 then proceeds to act 950, wherein it is determined whether port authorization was successful. If so, process 900 completes. If not, the process proceeds to act 942, wherein the peer is dissociated, and then to act 945, wherein the peer context is destroyed. Process 900 then completes.

It should be appreciated that, although the examples above describe an interface that provides the capability to invoke functionality relating to either virtualization or software-enabled access point capabilities, embodiments of the invention may provide an interface having the ability to invoke both virtualization and software-enabled access point capabilities. In addition, it should be appreciated that an interface implemented in accordance with embodiments of the invention may include different or additional components than those described above. Further, the example component interactions described above in Sections I and II are merely exemplary, as components may interact in any suitable manner to provide the capability to invoke virtualization and/or software-enabled access point functionality. Embodiments of the invention are not limited to being implemented in any particular manner.

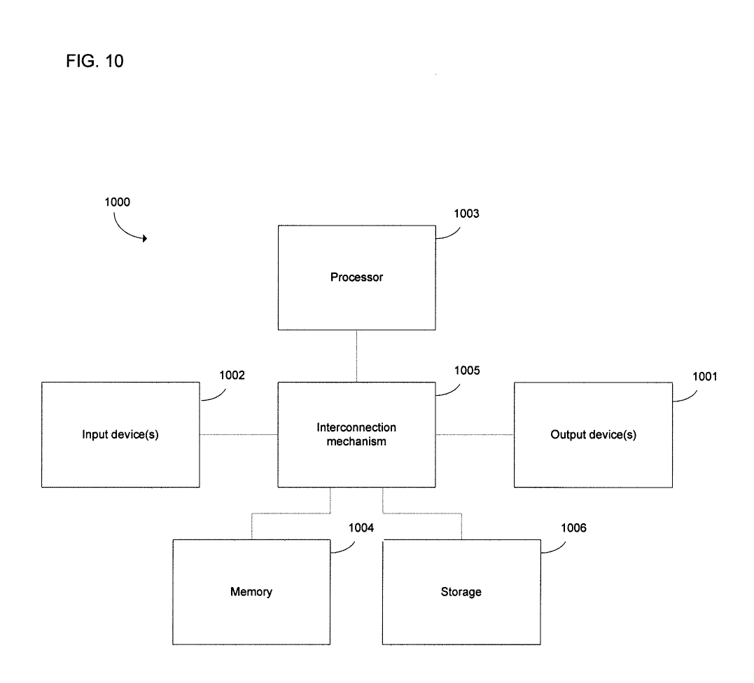

Various aspects of the systems and methods for practicing features of the invention may be implemented on one or more computer systems, such as the exemplary computer system 1000 shown in FIG. 10. Computer system 1000 includes input device(s) 1002, output device(s) 1001, processor 1003, memory system 1004 and storage 1006, all of which are coupled, directly or indirectly, via interconnection mechanism 1005, which may comprise one or more buses, switches, networks and/or any other suitable interconnection. The input device(s) 1002 receive(s) input from a user or machine (e.g., a human operator), and the output device(s) 1001 display(s) or transmit(s) information to a user or machine (e.g., a liquid crystal display). The processor 1003 typically executes a computer program called an operating system (e.g., a Microsoft Windows-family operating system, or any other suitable operating system) which controls the execution of other computer programs, and provides scheduling, input/output and other device control, accounting, compilation, storage assignment, data management, memory management, communication and dataflow control. Collectively, the processor and operating system define the computer platform for which application programs and other computer program languages are written.

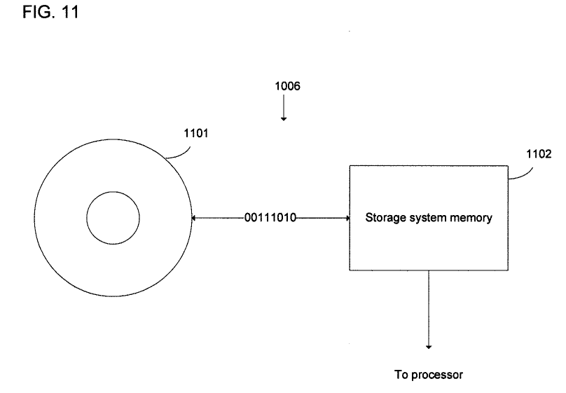

The processor 1003 may also execute one or more computer programs to implement various functions. These computer programs may be written in any type of computer program language, including a procedural programming language, object-oriented programming language, macro language, or combination thereof. These computer programs may be stored in storage system 1006. Storage system 1006 may hold information on a volatile or non-volatile medium, and may be fixed or removable. Storage system 1006 is shown in greater detail in FIG. 11.

Storage system 1006 typically includes a computer-readable and writable nonvolatile recording medium 1101, on which signals are stored that define a computer program or information to be used by the program. A medium may, for example, be a disk or flash memory. Typically, an operation, the processor 1003 causes data to be read from the nonvolatile recording medium 1101 into a volatile memory 1102 (e.g., a random access memory, or RAM) that allows for faster access to the information by the processor 1003 than does the medium 1101. The memory 1102 may be located in the storage system 1006, as shown in FIG. 11, or in memory system 1004, as shown in FIG. 10. The processor 1003 generally manipulates the data within the integrated circuit memory 1004, 1102 and then copies the data to the medium 1101 after processing is completed. A variety of mechanisms are known for managing data movement between the medium 1101 and the integrated circuit memory element 1004, 1102, and the invention is not limited thereto. The invention is also not limited to a particular memory system 1004 or storage system 1006.

The above-described embodiments of the present invention can be implemented in any of numerous ways. For example, the above-discussed functionality can be implemented using hardware, software or a combination thereof. When implemented in software, the software code can be executed on any suitable processor or collection of processors, whether provided in a single computer or distributed among multiple computers. In this respect, it should be appreciated that any component or collection of components that perform the functions described herein can be generically considered as one or more controllers that control the above-discussed functions. The one or more controllers can be implemented in numerous ways, such as with dedicated hardware, or by employing one or more processors that are programmed using microcode or software to perform the functions recited above. Where a controller stores or provides data for system operation, such data may be stored in a central repository, in a plurality of repositories, or a combination thereof.

Further, it should be appreciated that a (client or server) computer may be embodied in any of a number of forms, such as a rack-mounted computer, desktop computer, laptop computer, tablet computer, or other type of computer. Additionally, a (client or server) computer may be embedded in a device not generally regarded as a computer but with suitable processing capabilities, including a Personal Digital Assistant (PDA), a smart phone or any other suitable portable or fixed electronic device.

Also, a (client or server) computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms.

Additionally, software may be written using any of a number of suitable programming languages and/or conventional programming or scripting tools, and also may be compiled as executable machine language code or intermediate code that is executed on a framework or virtual machine.

In this respect, the invention may be embodied as a storage medium (or multiple storage media) (e.g., a computer memory, one or more floppy disks, compact disks, optical disks, magnetic tapes, flash memories, circuit configurations in Field Programmable Gate Arrays or other semiconductor devices, or other computer storage media) encoded with one or more programs that, when executed on one or more computers or other processors, perform methods that implement the various embodiments of the invention discussed above. The storage medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be provided in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer comprising:
a processor for executing instructions;
a set of computer executable instructions that, when executed by the processor, form an operating system for the computer, the operating system controlling one or more operations of the computer;
a radio constructed and arranged to send and receive wireless signals for communication with at least one device in a wireless network independent of frequency;
a miniport driver comprising a hardware interface adapted to communicate with the radio, provide control signals to the radio, and receive information regarding wireless signals received by the radio from the at least one device via a wireless network; and
an interface operable to invoke functionality implemented by the miniport driver, in response to a request issued by the operating system, the functionality relating to enabling the computer to maintain simultaneous connections with at least two wireless networks using the radio and/or to enabling the computer to operate as an access point for a wireless network;
wherein the interface invokes the functionality by making a call to the miniport driver using at least one OID.

2. The computer of claim 1, wherein the functionality comprises creating at least one new media access control (MAC) context, establishing a new connection via a wireless network, and defining a preferred MAC context.

3. The computer of claim 2, wherein the functionality associated with creating at least one new MAC context is invoked using at least one OID comprising OID_DOT11_CREATE_MAC, the functionality associated with establishing a new connection via a wireless network is invoked using at least one OID comprising OID_DOT11_CONNECT_REQUEST, and the functionality associated with defining a preferred MAC context is invoked using at least one OID comprising OID_DOT11_PREFERRED_MAC.

4. The computer of claim 1, wherein the functionality comprises instantiating at least one access point profile, defining an authentication algorithm, managing at least one probe request, and/or processing at least one association request.

5. The computer of claim 4, wherein the functionality associated with instantiating at least one access point profile is invoked using at least one OID comprising OID_DOT11_START_AP_REQUEST, the functionality associated with defining an authentication algorithm is invoked using at least one OID comprising OID_DOT11_ENABLED_AUTHENTICATION_ALGORITHM, the functionality associated with managing at least one probe request is invoked using at least one OID comprising OID_DOT11_ADDITIONAL_IE, and the functionality associated with processing at least one association request is invoked using at least one OID comprising OID_DOT11_INCOMING_ASSOCIATION_DECISION.

6. The computer of claim 1, wherein the interface is implemented separately from the operating system.

7. The computer of claim 1, wherein the radio is constructed and arranged to send and receive wireless signals using an IEEE 802.11 standard.

8. A method for use in a computer comprising an operating system, a radio operable to send and receive wireless signals to enable the computer to communicate with at least one device in a wireless network, and a miniport driver comprising a hardware interface adapted to communicate with the radio, provide control signals to the radio, and/or receive information regarding wireless signals received by the radio from at least one device via a wireless network, the method comprising an act of:
(A) providing an interface enabling the operating system to invoke virtualization functionality implemented by the miniport driver and/or the radio, the virtualization functionality relating to enabling the computer to maintain simultaneous connections with at least two wireless networks using the radio.

9. The method of claim 8, wherein the virtualization functionality comprises maintaining a plurality of virtual ports, each of the virtual ports being respectively associated with a corresponding wireless network, each virtual port being operable to handle wireless signals to be sent by the radio to, and wireless signals received from, the wireless network associated with the virtual port.

10. The method of claim 8, wherein the interface is operable to invoke the virtualization functionality by making a call to the miniport driver using at least one OID.

11. The method of claim 8, wherein the virtualization functionality comprises creating a new media access control (MAC) context, establishing a new connection via a wireless network, and defining a preferred MAC context, and wherein the virtualization functionality associated with creating a new MAC context is invoked using at least one OID comprising OID_DOT11_CREATE_MAC, the virtualization functionality associated with establishing a new connection via a wireless network is invoked using at least one OID comprising OID_DOT11_CONNECT_REQUEST, and the virtualization functionality associated with defining a preferred MAC context is invoked using at least one OID comprising OID_DOT11_PREFERRED_MAC.

12. The method of claim 8, wherein the interface comprises at least one filter driver operable to pass information between the operating system and the miniport driver.

13. The method of claim 8, wherein the connections include at least one connection which employs an IEEE 802.11 standard.

14. The method of claim 8, further comprising an act of:
(B) providing an interface enabling the operating system to invoke access point functionality implemented by the miniport driver and/or the radio which comprises enabling the computer to act as a wireless network access point.

15. The method of claim 14, wherein the access point functionality comprises instantiating an access point profile, defining an authentication algorithm, managing at least one probe request, and/or processing at least one association request, and wherein the access point functionality associated with instantiating an access point profile is invoked using at least one OID comprising OID_DOT11_START_AP_REQUEST, the access point functionality associated with defining an authentication algorithm is invoked using at least one OID comprising OID_DOT11_ENABLED_AUTHENTICATION ALGORITHM, the access point functionality associated with managing at least one probe request is invoked using at least one OID comprising OID_DOT11_ADDITIONAL_IE, and the access point functionality associated with processing at least one association request is invoked using at least one OID comprising OID_DOT11_INCOMING_ASSOCIATION_DECISION.

16. At least one computer storage medium encoded with instructions which, when executed, perform a method, the method for use in a computer comprising an operating system, a radio operable to send and receive wireless signals to enable the computer to communicate with at least one device in a wireless network, and a miniport driver comprising a hardware interface adapted to communicate with the radio, provide control signals to the radio, and/or receive information regarding wireless signals received by the radio from at least one device via a wireless network, the method comprising an act of:
(A) providing an interface enabling the operating system to invoke access point functionality implemented by the miniport driver and/or radio, the access point functionality relating to enabling the computer to act as an access point for a wireless network.

17. The at least one computer storage medium of claim 16, wherein the interface is operable to invoke the functionality by making a call to the miniport driver using at least one OID.

18. The at least one computer storage medium of claim 16, wherein the access point functionality comprises instantiating an access point profile, defining an authentication algorithm, managing at least one probe request, and/or processing at least one association request, and wherein the access point functionality associated with instantiating an access point profile is invoked using at least one OID comprising OID_DOT11_START_AP_REQUEST, the access point functionality associated with defining an authentication algorithm is invoked using at least one OID comprising OID_DOT11_ENABLED_AUTHENTICATION_ALGORITHM, the access point functionality associated with managing at least one probe request is invoked using at least one OID comprising OID_DOT11_ADDITIONAL_IE, and the access point functionality associated with processing at least one association request is invoked using at least one OID comprising OID_DOT11_INCOMING_ASSOCIATION_DECISION.

19. The at least one computer storage medium of claim 16, wherein the method further comprises an act of:
(C) providing an interface enabling the operating system to invoke virtualization functionality implemented by the miniport driver and/or the radio, the virtualization functionality relating to enabling the computer to maintain simultaneous connections with at least two wireless networks using the radio.

20. The at least one computer storage medium of claim 19, wherein the virtualization functionality comprises creating a new media access control (MAC) context, establishing a new connection via a wireless network, and defining a preferred MAC context, and wherein the virtualization functionality associated with creating a new MAC context is invoked using at least one OID comprising OID_DOT11_CREATE_MAC, the virtualization functionality associated with establishing a new connection via a wireless network is invoked using at least one OID comprising OID_DOT11_CONNECT_REQUEST, and the virtualization functionality associated with defining a preferred MAC context is invoked using at least one OID comprising OID_DOT11_PREFERRED_MAC.
